(19) United States
(12) Patent Application Publication
(10) Pub. No.: US 2022/0250454 A1
(43) Pub. Date: Aug. 11, 2022

(54) REAR STRUCTURE OF VEHICLE

(71) Applicant: HONDA MOTOR CO., LTD., Tokyo (JP)

(72) Inventors: Yoshinori MIYAKE, Tokyo (JP); Masashi KASUYA, Tokyo (JP); King shing CHENG, Tokyo (JP); Keisuke HAYASHI, Tokyo (JP); Kyosuke ICHINOHE, Tokyo (JP); Tsukasa KISHIDA, Tokyo (JP)

(21) Appl. No.: 17/648,681

(22) Filed: Jan. 24, 2022

(30) Foreign Application Priority Data
Feb. 5, 2021 (CN) 202110163334.0

(51) Int. Cl. B60J 5/10

(52) U.S. Cl. CPC B60J 5/107; E05Y 2900/546; B60J 5/106

(57) ABSTRACT

Provided is a rear structure of a vehicle. The rear structure includes: a rear opening at a rear of a vehicle body; and an opening-closing member configured to open and close the rear opening. The opening-closing member has cushioning members respectively disposed on both Side portions in a vehicle body width direction. The rear opening has contact members respectively disposed on both side borders in the vehicle body width direction, the contact members being contactable with the cushioning members. Each cushioning member has two surfaces, one of which extends in a vehicle body upward-downward direction and the other of which extends in the vehicle body width direction. The two surfaces of each cushioning member are disposed to be contactable with a corresponding one of the contact members.

This application is baaed on and claims the benefit of priority from Chinese Patent Application No. 202110163334.0, filed on 5 Feb. 2021, the content of which is incorporated herein by reference.

### BACKGROUND OF THE INVENTION

### Field of the Invention

The present disclosure relates to a rear structure of a vehicle.

### Related Art

A known rear structure of a vehicle includes a rear gate as an opening-closing member that is attached, in an openable and closable manner, to a rear opening located at the rear of a vehicle body (see, for example, Patent Document 1).

This rear gate of the known art has, at its both ends in a width direction, stepped portions protruding toward the vehicle compartment, and buffer members provided on the stepped portions. When the rear gate is closed, the buffer members come into contact, in a vehicle body width direction, with a weather strip provided along the periphery of the rear opening, and absorb a load component acting in the vehicle body width direction. In this way, the buffer members prevent the rear gate from rolling,

Patent Document 1: Japanese Unexamined Patent Application, Publication No. 2008-247112

### SUMMARY OF THE INVENTION

However, since the buffer members of the conventional vehicle rear structure prevent the rear gate from roiling by unidirectionally contacting with the weather strip in the vehicle body width direction, the weather strip is subjected to a considerable load at the time of rolling. Moreover, since the load of the rear gate is directly applied to the weather strip, the weather strip is heavily loaded when the rear gate is closed. As a result, the weather strip is likely to be deformed, which makes it difficult for the weather strip to maintain its sealing function for a long period of time. It becomes also difficult for the buffer members and the weather strip to maintain their function of preventing the rear gate from rolling for a long period of time.

It is an object of the present disclosure to provide a rear structure of a vehicle body, the rear structure being capable of reducing a load on a weather strip and maintaining a function of preventing rolling of an opening-closing member over a long period of time.

A first aspect of the present disclosure is directed to a rear structure of a vehicle. The rear structure according to the first aspect includes: a rear opening (e.g., a rear opening 101 to be described later) at a rear of a vehicle body (e.g., a vehicle body 100 to be described later); and an opening-closing member (e.g., a rear gate 1 to be described later) configured to open and close the rear opening. The opening-closing member has cushioning members (e.g., cushioning members 3 to be described later) respectively disposed on both side portions (e.g., side portions lb to be described later) in a vehicle body width direction. The rear opening has contact members (e.g., contact members 4 to be described later) respectively disposed on both side borders (e.g., side borders 101c to be described later) in the vehicle body width direction, the contact members being contactable with the cushioning members. Each cushioning member has two surfaces (e.g., a first surface 331 and a second surface 332 to be described later), one of which extends in a vehicle body upward-downward direction and the other of which extends in the vehicle body width direction. The two surfaces of each cushioning member, are disposed to be contactable with a corresponding one of the contact members.

A second aspect, is an embodiment of the first aspect. In the rear structure according to the second aspect, each contact member may have a first contact surface (e.g., a first, contact surface 431 to be described later) along the vehicle body upward-downward direction and a second contact surface (e.g., a second contact surface 432 to be described later) along the vehicle body width direction. The first contact surface and the second contact surface may be disposed to be contactable with the two surfaces of a corresponding one of the cushioning members on the opening-closing member.

A third aspect is an embodiment of the second aspect. In the rear structure according to the third aspect, each cushioning member may have, on the surface contactable with the first contact surface of the corresponding one of the contact members, a protuberant portion (e.g., a protuberant portion 33 to be described later) protruding toward the first contact surface of the corresponding one of the contact members.

A fourth aspect is an embodiment of any one of first to third aspects. In the rear structure according to the fourth aspect, the opening-closing member may have bent portions (e.g., bent portions If, If to be described later) that bend obliquely downward in a direction from a front to the rear of the vehicle body, and the cushioning members may be provided on the bent portions.

A fifth aspect is an embodiment of any one of first to fourth aspects. In the rear structure according to the fifth aspect, the opening-closing member may have closed-section portions (e.g., closed-section portions 10 to be described later) in both the side portions in the vehicle body width direction, and the cushioning members may be respectively attached to the closed-section portions.

A sixth aspect is an embodiment of any one of first to fifth aspects. In the rear structure according to the sixth aspect, the opening-closing member is provided with a mounting part (e.g., a mounting part 5 to be described later) for mounting an aero part, the mounting part being disposed above each cushioning member.

According to the first aspect, each cushioning member, which is configured to receive a load of the opening-closing member at two surfaces, i.e., the surface along the vehicle body upward-downward direction and the surface along the vehicle body width direction, can unaidedly perform a function of preventing the opening-closing member from rolling. This feature makes it possible to reduce a load on a weather strip, whereby the rear structure of a vehicle body is provided which can maintain, over a long period of time, a sealing function of the weather strip and a function of preventing the opening-closing member from rolling.

According to the second aspect, each contact member, which is disposed to be contactable with the corresponding cushioning member, can also unaidedly receive the load of the opening-closing member via the cushioning member, just like the cushioning member. Since the contact member is a one-piece component, it has a simple structure for mounting to the vehicle body.

According to the third aspect, since the surface of the protuberant portion of the cushioning member comes into contact with the first contact surface of the contact member, the load in the vehicle body width direction applied when the opening-closing member rolls can be effectively received.

According to the fourth aspect, the cushioning members are disposed at the bent portions of the opening-closing member that are likely to receive a load when the rear opening is closed. Due to this configuration, an impact given to the bent portions by the opening-closing member can be cushioned by means of contact of the cushioning members with the contact members, and the opening-closing member can be reinforced.

According to the fifth aspect, each closed-section portion has high strength and rigidity. Thus, attaching the cushioning members to the closed-section portions contributes to an increase in the strength of the cushioning members themselves, and makes it possible to further effectively receive the load in the upward-downward direction that is applied when the opening-closing member is closed and the load in the vehicle body width direction that is applied when the opening-closing member rolls.

According to the sixth aspect, since the aero part is mounted above the cushioning members, a load of the aero part can also be received by means of contact between the cushioning members and the contact members, thereby making it possible to reduce the load applied on the opening-closing member by the aero part.

### BRIEF DESCRIPTION OF THE DRAWINGS

FIG. 1 is a perspective view illustrating a rear structure of a vehicle;

FIG. 2 is a cross-sectional view taken along line A-A in FIG. 1;

FIG. 3 is a perspective view illustrating a cushioning member;

FIG. 4 is a diagram illustrating an opening-closing member as viewed from obliquely above, and showing a portion of the opening-closing member in a cutaway view; and

FIG. 5 is a side view illustrating a rear end portion of the opening-closing member, and showing a portion of the rear end portion in a cutaway view.

### DETAILED DESCRIPTION OF THE INVENTION

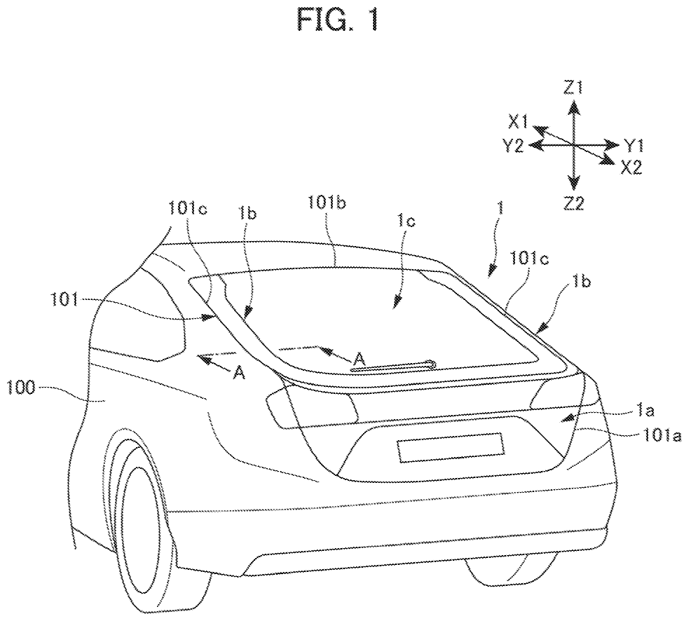

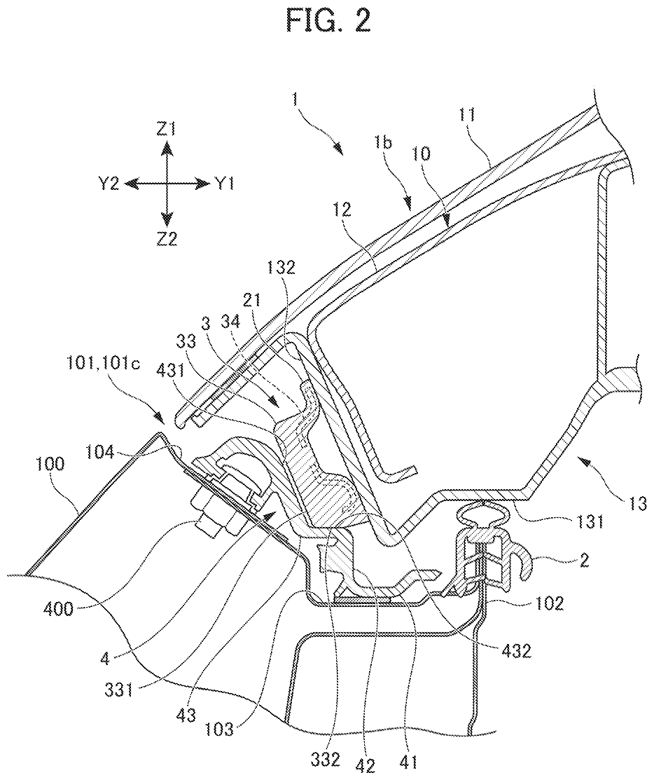

An embodiment of. the present disclosure will be described in detail with reference to the drawings. As illustrated in FIGS. 1 and 2, a vehicle body 100 has a rear opening 101 at its rear. A rear gate 1 is attached to the vehicle body 100 such that the rear gate 1 can open and close the rear opening 101.

The drawings indicate directions as follows. X1-X2 refers to a front-rear direction of the vehicle body 100. The X1 direction is a forward direction toward the front of the vehicle body 100, and the X2 direction is a rearward direction toward the rear of the vehicle body 100. Y1-Y2 refers to a width direction of the vehicle body 100. When the vehicle body 100 is viewed from the rear, the Y1 direction is a right direction with respect to the vehicle body 100, and the Y2 direction is a left direction with respect to the vehicle body 100. Z1-Z2 refers to an upward-downward direction of the vehicle body 100. The 21 direction is an upward direction with respect to the vehicle body 100, and the 22 direction is a downward direction with respect to the vehicle body 100.

The rear gate 1 is an opening-closing member that opens and closes the rear opening 101 of the vehicle body 100. As illustrated in FIGS. 1 and A, the rear gate 1 has: a rear end portion 1a configured to close a rear end opening 101a that is a portion of the rear opening 101; a pair of side portions 1b, 1b respectively extending toward the front of the vehicle body 100 from both ends in the vehicle body width direction of the rear end portion 1a; and a glass panel 1c attached continuously to the rear end portion 1a and both the side portions 1b, 1b. The side portions 1b, 1b and the glass panel 1c close an upper opening 101b that is a portion of the rear opening 101.

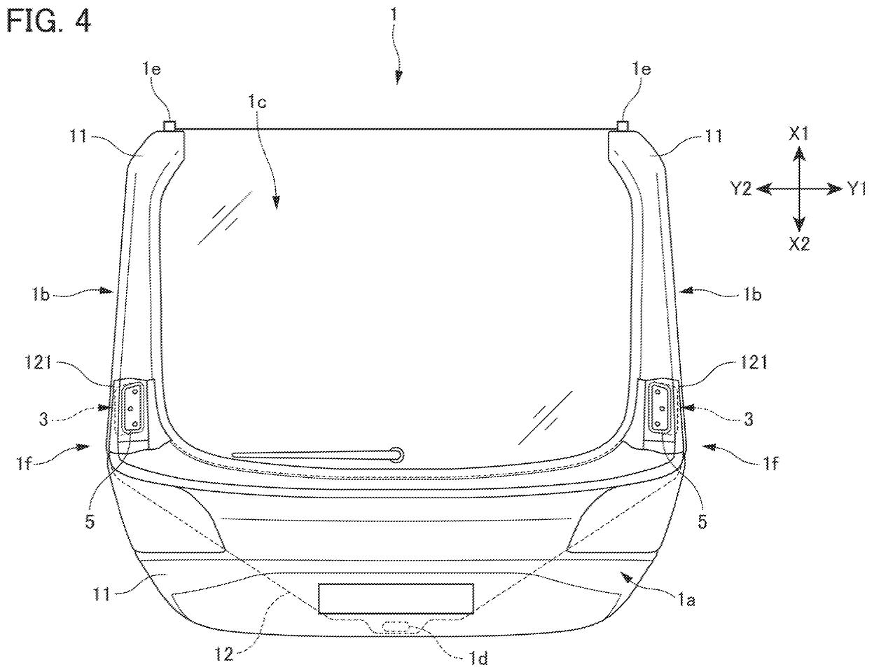

As illustrated in FIG. 4, a striker Id is provided at a lower location in the rear end portion 1a of the rear gate 1. 3y means of the striker 1d, the rear gate 1 is engaged with and secured to the vehicle body 100. Hinges 1e, 1e are respectively provided at front ends of the side portions 1b, 1b of the rear gate 1. By means of the hinges 1e, 1e, the rear gate 1 is attached to the vehicle body 100 in an operable and closable manner. The rear gate 1 is attached to the vehicle body 100 via three points: the striker Id and the hinges 1e, 1e.

The rear gate 1 of the present embodiment includes an outer panel 11, a mid-panel 12, and an inner panel 13. The outer panel 11 is a resin panel that constitutes an outer surface of the rear gate 1. The mid-panel 12 is a metal member that is disposed between the outer panel 11 and the inner panel 13, and that constitutes, together with the inner panel 13, a skeleton of the rear gate 1. The inner panel 13 is a resin panel that constitutes an inner surface of the rear gate 1. The outer panel 11 extends over the rear end portion 1a and the side portions 1b, 1b of the rear gate 1. The rear gate 1 is light in weight because it includes the outer panel 11 and inner panel 13 that are both made of resin.

As illustrated in FIG. 2, the vehicle 100 has an upright wall 102 that extends substantially vertically upward toward the upper opening 101b of the rear opening 101. While FIG. 2 illustrates only a left portion in the vehicle body width direction of the vehicle body 100, the upright wall 102 surrounds the rear opening 101.

A weather strip 2 is attached to the upright wall 102 so that the weather strip 2 projects upwardly. The weather strip 2 is a sealing member that provides sealing between the rear gate 1 and the vehicle body 100. As illustrated in FIG. 2, the inner panel 13 of the rear gate 1 has a sealing surface 131 that is in contact with the weather strip 2 from above when the rear gate 1 is closed. The sealing surface 131 is directed downward toward the vehicle body 100 and faces the weather strip 2. When the rear gate 1 closes the rear opening 101 of the vehicle body 100, the sealing surface 131 of the rear gate 1 is in contact with the weather strip 2, whereby the weather strip 2 is compressed to deform. As a result, the rear opening 101 becomes sealed.

As illustrated in FIG. 2, a portion of the inner panel 13 located in the side portion 1b of the rear gate 1 has an inclined surface 132, which is closer in the vehicle body width direction to the outside than the sealing surface 131, and faces outward and slightly downward. The inclined surface 132 has a cushioning member 3 attached thereto.

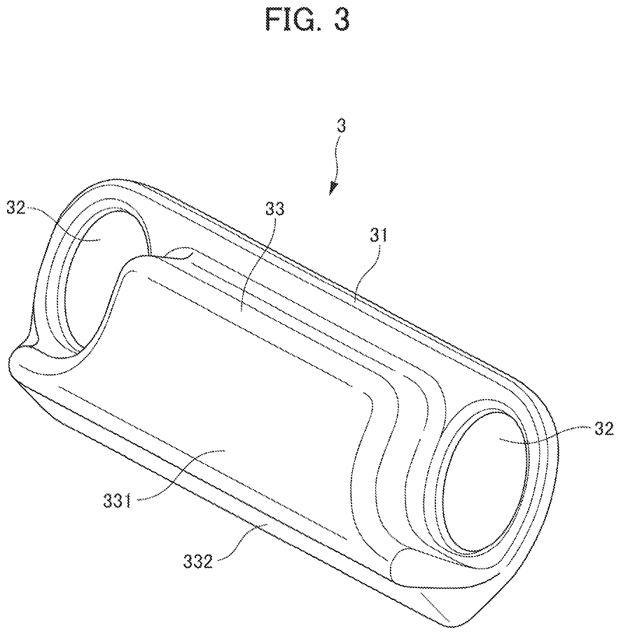

As illustrated in FIGS. 2 and 3, the cushioning member 3 is made of, for example, rubber and has a substantially rectangular parallelepiped block shape with predetermined height, width, and thickness. In detail, the cushioning member 3 has a cushioning member body 31 that has a rectangular shape long in the front-rear direction of the vehicle body 100, a pair of mounting holes 32, 32 that are respectively formed at both lengthwise end portions of the cushioning member body 31, and a protuberant portion 33 that is located between the pair of mounting holes 32, 32 and protrudes from the cushioning member body 31 to the outside in the vehicle body width direction.

The cushioning member 3 has two surfaces: a first surface 331 extending in the upward-downward direction of the vehicle body 100 and a second surface 332 extending in the vehicle body width direction. The first, surface 331 is constituted by a surface of the protuberant portion 33, the surface being laterally oriented and long in the front-rear direction of the vehicle body 100 (the surface facing a side of the vehicle body 100. The second surface 332 is constituted by a lower surface of the protuberant portion 33 (the surface facing downward with respect to the vehicle body 100).

In the front-rear direction of the vehicle body 100, the cushioning member 3 has a shape symmetrical about the protuberant portion 33. Therefore, the cushioning member 3 can be used for both the left and right sides of the rear gate 1. The cushioning member 3 includes a metal core member 34 inserted therein to increase strength and rigidity.

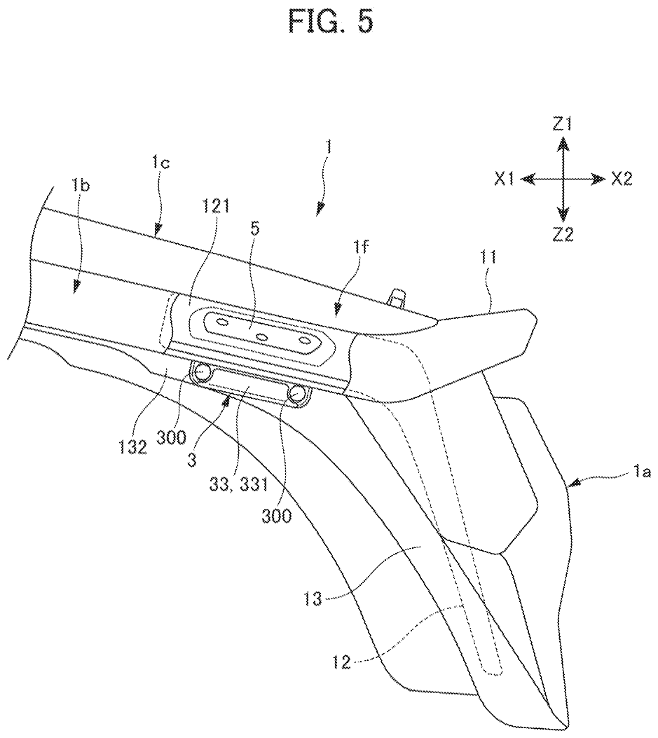

As illustrated in FIG. 5, the cushioning member 3 is fixed to the inclined surface 132 of the inner panel 13 located on the side portion 1b of the rear gate 1, using bolts 300, 300 penetrating the mounting holes 32, 32 such that the length direction of the cushioning member 3 extends in the front-rear direction of the vehicle body 100. As illustrated in FIG. 3, the mounting holes 32, 32 have a shape that is long in the vertical direction. When the cushioning member 3 is attached to the inclined surface 132 with the bolts 300, 300, the thus-shaped mounting holes allow for fine adjustment, of an attaching position of the cushioning member 3, the attaching position varying depending on vehicle models. Thus, the cushioning members 3 can be used in common for various vehicle models.

As illustrated in FIG. 2, the vehicle body 100 has a first support surface 103 and a second support surface 104 in each of side borders 101c, 101c of the rear opening 101 in the vehicle body width direction. The first support surface 103 and the second support surface 104 are closer to the outside in the vehicle body width direction than the upright wall 102. The first support surface 103 is constituted by a flat surface of the vehicle body 100 facing in the upward direction, and is located adjacent to the outer side of the upright wail 102 in the vehicle body width direction. The second support surface 104 is constituted by an inclined surface slightly upwardly facing the inside of the rear opening 101, and is located adjacent to the outer side of the first support surface 103 in the vehicle body width direction.

The vehicle body 100 is provided with a contact member 4 that is disposed over the first support surface 103 and the second support surface 104, and that receives a load of the rear gate i applied via the cushioning member 3. The contact member 4 is made of synthetic fibers such as Nylon 66. As illustrated in FIG. 2, the contact member 4 has a lower end support portion 41 that is placed on the first support surface 103, a rising portion 42 that rises upward from an cuter end in the vehicle body width direction of the lower end support portion 41, and a contact portion 43 that extends from an upper end of the rising portion 42. along the second support surface 104, which is located toward the outside in the vehicle body width direction. These portions 41, 42, and 43 are integrated with each other. The contact member 4 is attached, at its contact portion 43, to the second support surface 104 with a bolt 400.

As illustrated in FIG. 2, the contact portion 43 of the contact member 4 has a first contact surface 431 extending in the upward-downward direction of the vehicle body 100 and a second contact surface 432 extending in the vehicle body width direction. The first contact surface 431 is located at the uppermost portion of the contact member 4. The second contact surface 432 extends laterally inwardly in the vehicle body width direction from the lower end of the first contact surface 431 and is integrally connected to the upper end of the rising portion 42.

As illustrated in FIGS. 1 and 2, when the rear, gate 1 closes the rear opening 101 of the vehicle body 100, the cushioning member 3 of the rear gate 1 is positioned in close proximity to the first contact surface 431 of the contact member 4 and is in contact with the second contact surface 432. In detail, the first surface 331 of the protuberant portion 33 of the cushioning member 3 is in close proximity to the first contact surface 431 of the contact member 4 with a slight gap interposed therebetween. The second surface 332 of the protuberant portion 33 of the cushioning member 3 is in surface contact with the second contact surface 432 of the contact member 4. In other words, in the upward-downward direction of the vehicle body 100, the second surface 332 of the protuberant portion 33 of the cushioning member 3 is in contact with the second contact surface 432 of the contact member 4, while in the vehicle body width direction, the first surface 331 of the protuberant portion 33 of the cushioning member 3 is in close proximity to the first contact surface 431 of the contact member 4. The first surface 331 of the protuberant portion 33 of the cushioning member 3 comes into contact with the first contact surface 431 of the contact member 4 when the rear gate 1 is deformed due to a force acting on the rear gate 1 in the vehicle body width direction, such as when the vehicle body 10C roils or when the rear gate 1 is closed. Therefore, the cushioning member 3 can receive the load of the rear gate 1 at two surfaces: the first surface 331, which is positioned in close proximity to the first contact surface 4 31 of the contact member 4, and the second surface 332, which comes into contact with the second contact surface 432 of the contact member 4.

As can be seen, since the cushioning member 3 can receive the load of the rear gate i at two surfaces, i.e., the first surface 331 along the upward-downward direction of the vehicle body 100 and the second surface 332 along the vehicle body width direction, rolling of the rear gate 1 can be prevented by the cushioning member 3 alone. Moreover, when the rear gate 1 is closed, the cushioning member 3 can receive the load applied from above, by means of contact of the second surface 332 of the cushioning member 3 with the second contact surface 432 of the contact member 4. This feature makes it possible to reduce a load on the weather strip 2. As a result, the sealing function of the weather strip 2 and a function of preventing the rear gate 1 from roiling can be maintained over a long period of time. Furthermore, when the rear gate 1 is closed, the cushioning member 3 and the contact member 4 coming into contact with each other receive the rear gate 1, thereby reducing overstroke of the rear gate 1 and preventing the rear gate 1 from interfering with the vehicle body 100.

The contact member 4 has the first contact surface 431 along the upward-downward direction of the vehicle body 100 and the second contact surface 432 along the vehicle body width direction. The first contact surface 431 is disposed so that it can contact with the first surface 331 of the cushioning member 3, and the second contact surface 432 is disposed so that it can contact with the second surface 332 of the cushioning member 3. Due to this configuration, the contact member 4 can unaidedly receive the load of the rear gate 1 via the cushioning member 3, just like the cushioning member 3. In addition, the contact member 4, which is a one-piece component, has a simple structure for mounting to the vehicle body 100.

As illustrated in FIGS. 4 and 5, the rear gate 1 has bent portions 1f, 1f, at connections between the side portions 1b, 1b and the rear end portion 1a of the rear gate 1. Each bent portion 1f is where the rear gate 1 bends from the rear end portion 1a toward the upper surface of the rear gate 1. The bent portions 1f, 1f, bend obliquely downward in a direction from the front to the rear of the vehicle body 100. Since the rear gate 1 is attached to the vehicle body 100 via the three points, i.e., the striker Id and the two hinges 1e, 1e, when the rear gate 1 closes the rear opening 101, a load is likely to be applied to the bent portions 1f, 1f that are located at substantial midpoints between the three points. The cushioning members 3 are disposed at positions that correspond to the bent portions 1f, 1f. The contact members 4 are disposed at positions that correspond to the cushioning members 3 when the rear gate i closes the rear opening 101, and can receive, at the bent portions 1f, 1f, the load of the rear gate 1 applied when the rear gate 1 is closed, via the cushioning members 3. This configuration can cushion an impact given to the bent portions 1f, 1f of the rear gate 1 when the rear gate 1 is closed, and can reinforce the rear gate 1.

As illustrated in FIG. 3, the cushioning member 3 has, as its surface contactable with the first contact surface 431 of the contact member 4, the protuberant portion 33 that protrudes toward the first contact surface 431 of the contact member 4. When the cushioning member 3 is in contact with the contact member 4, the first surface 331, which is the surface of the protuberant portion 33, is in contact with the first contact surface 431 of the contact member 4. Consequently, the cushioning member 3 can effectively receive, by means of the protuberant portion 33, a load in the vehicle body width direction applied when the rear gate 1 rolls, in comparison with a case where the cushioning member 3 is devoid of the protuberant portion 33.

As illustrated in FIG. 2, the side portions 1b, 1b of the rear gate 1 each have a closed-section portion 10. The closed-section portion 10 is a hollow portion the periphery of which is closed by the mid-panel 12 and the inner panel 13 in the vehicle body width direction and the vehicle body upward-downward direction. The inclined surface 132, to which the cushioning member 3 is attached, is constituted by a side surface of the closed-section portion 10. In other words, the cushioning members 3 are attached to the closed-section portions 10 of the rear gate 1. In the rear gate X, the closed-section portions 10, which have a hollow shape, have high strength and rigidity. Attaching the cushioning members 3 to the closed-section portions 10 contributes to an increase in the strength of the cushioning members 3 themselves, and makes it possible to further effectively receive the load in the upward-downward direction of the vehicle body 100 applied when the rear gate 1 is closed and the load in the vehicle body width direction applied when the rear gate 1 rolls.

As illustrated in FIGS. 4 and 5, the rear gate 1 is provided with mounting parts 5, 5 for mounting an aero part (not shown), such as a spoiler. The mounting parts 5, 5 are respectively provided above the cushioning members 3, 3. The mounting parts 5, 5 are disposed on an upper surface 121 of the mid-panel 12 in the side portions 1b, 1b of the rear gate 1. Due to this configuration, since the aero part is mounted above the cushioning members 3, 3, a load of the aero part can also be received by means of contact of the cushioning members 3 with the contact members 4. Thus, this configuration makes it possible to reduce the load applied by the aero part on the rear gate 1, and can prevent interference of the rear gate 1 having the aero part mounted thereon with the vehicle body 100.

What is claimed is:

1. A rear structure of a vehicle, the rear structure comprising:
a rear opening at a rear of a vehicle body; and
an opening-closing member configured to open and close the rear opening,
wherein the opening-closing member has cushioning members respectively disposed on both side portions in a vehicle body width direction,
wherein the rear opening has contact members respectively disposed on both side borders in the vehicle body width direction, the contact members being contactable with the cushioning members,
wherein each cushioning member has two surfaces, one of which extends in a vehicle body upward-downward direction and the other of which extends in the vehicle body width direction, and
wherein the two surfaces of each cushioning member are disposed to be contactable with a corresponding one of the contact members.

2. The rear structure according to claim 1,
wherein each contact member has a first contact surface along the vehicle body upward-downward direction and a second contact surface along the vehicle body width direction, and
wherein the first contact surface and the second contact surface are disposed to be contactable with the two surfaces of a corresponding one of the cushioning members on the opening-closing member.

3. The rear structure according to claim 2,
wherein each cushioning member has, on the surface contactable with the first contact surface of the corresponding one of the contact members, a protuberant portion protruding toward the first contact surface of the corresponding one of the contact members.

4. The rear structure according to claim 1,
wherein the opening-closing member has bent portions that bend obliquely downward in a direction from a front to the rear of the vehicle body, and
wherein the cushioning members are provided on the bent portions.

5. The rear structure according to claim 1,
wherein the opening-closing member has closed-section portions in both the side portions in the vehicle body width direction, and
wherein the cushioning members are respectively attached to the closed-section portions.

6. The rear structure according to claim 1,
wherein the opening-closing member is provided with a mounting part for mounting an aero part, the mounting part being disposed above each cushioning member.
